(19) United States
(12) Patent Application Publication
(10) Pub. No.: US 2007/0189411 A1
(43) Pub. Date: Aug. 16, 2007

(54) Audio encoding and transmission method

(75) Inventor: Douglas A. Goss, Plano, TX (US)

Correspondence Address: HOWISON & ARNOTT, L.L.P, P.O. BOX 741715, DALLAS, TX, 75374-1715, US

(73) Assignee: ViewCast.com, Inc.

(21) Appl. No.: 11/353,750

(22) Filed: Feb. 14, 2006

(51) Int. Cl. H04L 27/10

(52) U.S. Cl. 375/272

(57) ABSTRACT

A method of transmitting audio signals is disclosed. The method includes, receiving a multi-channel analog audio signal, converting the analog audio signal to a digital audio signal with a first sample bit length and a first sample rate, providing a header for each discrete sample of the digital audio signal to produce a sample packet with a second sample bit length, frequency shift key (FSK) encoding the sample packets on first and second audio transmission frequencies, and transmitting the sample packets.

### TECHNICAL FIELD OF THE INVENTION

This disclosure relates generally to audio encoding and audio transmission methods, and more particularly to audio encoding methods and transmission methods for providing audio signals on the same carrier line as video signals.

### BACKGROUND OF THE INVENTION

Traditionally, analog audio and video signals have been transmitted over separate lines or cables. Additional cables may also be required where there is more than one discrete audio channel provided in a given audiovisual signal feed. For example, stereo audio provides for two discrete channels of audio and thus two audio signal lines are typically required to transmit the complete stereo audio signal. In other audio systems, such as those providing additional front, rear, center, or other channels, a separate line may also be required for each such additional channel in order to properly convey the full audio signal from one location to another.

In some instances, additional channel information may be extracted from standard stereo audio lines through special processing techniques such as the Pro Logic system from Dolby Laboratories of San Francisco, Calif. However, this system and those similar to it typically still require multiple lines or cables to provide the full audio signal and may not actually fully replicate each channel in a multi-channel signal. Additionally, these systems typically apply only to the audio portion of a complete audiovisual signal and are therefore not suitable for providing a single-line, multi-channel audio and video signal.

In other instances, multiple channels of analog audio may be frequency modulated (FM) and transmitted on the same line as a video signal. However, this method typically limits the quality of the audio signal. Additionally, problems can occur from the multiple analog audio and video signals propagating along the same medium such as cross talk between the audio signals and between the audio and video signals.

### SUMMARY OF THE INVENTION

The present invention disclosed and claimed herein, in one aspect thereof, comprises a method of transmitting audio signals. The method includes receiving a multi-channel analog audio signal and converting the analog audio signal to a digital audio signal. The digital audio signal has a first sample bit length and a first sample rate. A header is provided for each discrete sample of the digital audio signal to produce a sample packet with a second sample bit length. The samples with headers are frequency shift key (FSK) encoded on first and second audio transmission frequencies and transmitted.

### BRIEF DESCRIPTION OF THE DRAWINGS

For a more complete understanding of the present invention and the advantages thereof, reference is now made to the following description taken in conjunction with the accompanying Drawings in which:

FIG. 1 is a block diagram of an audio encoder;

FIG. 2 is a flow chart of one embodiment of a method of encoding audio data;

FIG. 3 is a block diagram of an audio decoder;

FIG. 4 is a flow chart of one embodiment of a method of decoding audio data;

FIG. 5 is a logical diagram of one embodiment of a data packet corresponding to encoded audio signals;

FIG. 6 is timing diagram of a data signal according to aspects of the present disclosure; and

FIG. 7 is a flow chart corresponding to one embodiment of a method for synchronizing with a clock signal.

### DETAILED DESCRIPTION OF THE INVENTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

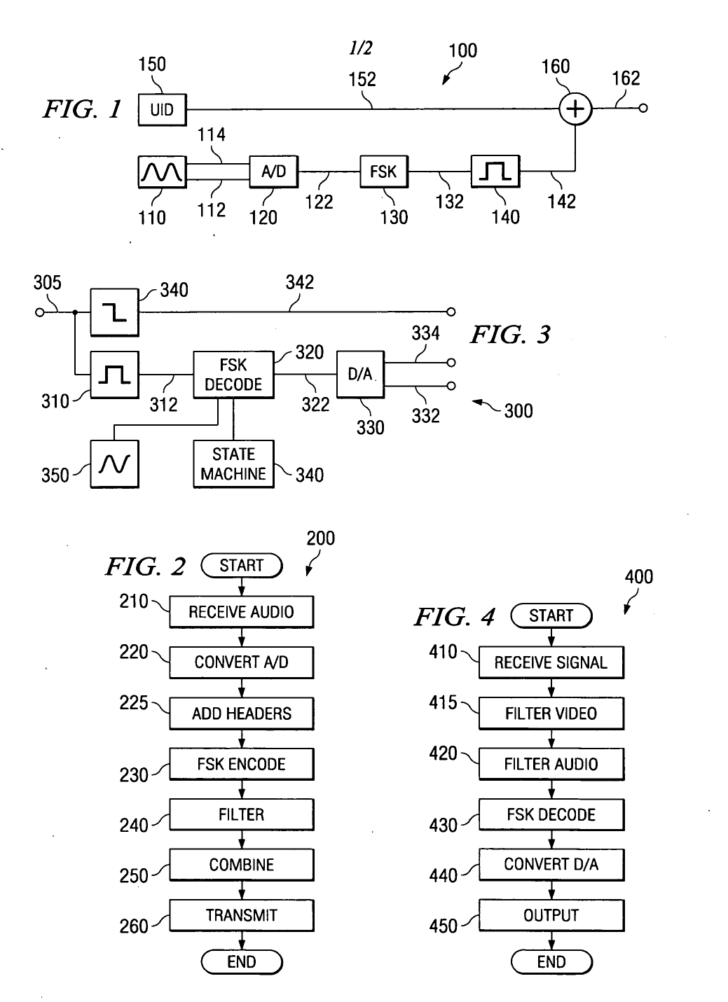

Referring now to FIG. 1, a block diagram of an audio encoder 100 according to aspects of the present disclosure is shown. An audio source 110 provides an audio signal that will be encoded for transmission to a receiver. The audio source 110 may provide a stereo audio signal providing left and right audio channel signals on inputs 112, 114, respectively. The audio encoder 100 may be configured to accept a standard audio jack as an input, Radio Corporation of America (RCA) style connectors, output from a standard Audio Engineering Society (AES) encoder/decoder, or other balanced or unbalanced audio inputs as dictated by the needs of the user. The audio inputs 112, 114 are provided to an analog to digital (“A/D”) converter 120. In one embodiment, the A/D converter 120 converts an analog signal to a digital signal having two 24-bit outputs at 48 KHz. In other embodiments the A/D converter may be configured to accept different input signals and provide different output signals. In some embodiments, when an incoming signal is already digitized, the A/D converter 120 may not be utilized. The A/D converter 120 may be a commercially available A/D converter or it may be specifically built for use with the audio encoder 100. The A/D converter 120 may be part of an application specific integrated circuit (ASIC), may be partially or completely implemented in control software of a multipurpose audio processing device, may be partially or completely programmed using a field programmable gate array (FPGA), or may be implemented as a combination of these methods.

The digitized signal from the A/D converter 120 may be produced on output 122. The output 122 may provide a serial stream having both right and left audio signals included therein. In one embodiment, the output 122 is a standard I2S interface. The digitized audio signals are frequency shift key (“FSK”) encoded by FSK encoder 130. The frequency to which the digital audio signals are keyed may be chosen based upon the needs of the user. In one embodiment the 0's (zeros) of the digitized signals may be represented by a carrier of approximately 9 MHz and the 1's (ones) of the digitized signals may be represented by a carrier wave of approximately 12 MHz. Thus, the digital bits of the signals may be transmitted by a carrier signal alternating between 9 MHz (representing a 0 bit) and 12 MHz (representing a 1 bit). As with the A/D converter, the FSK encoder 130 may comprise commercially available components, such as an operational amplifier, an ASIC, an FPGA, software for a general processing system, or a combination thereof.

The FSK encoder 130, or another component of the audio encoder 100, may also function to add a preamble or header to each of the audio samples. In the present embodiment, an 8-bit header is attached to each of the 24-bit audio samples resulting in a 32-bit data packet for each audio sample. The header can be used to identify whether a given sample is a left or right audio-channel sample, to provide clock information, to provide error checking, or for other uses. Possible formats of the attached headers are described in greater detail below. With the attached headers, each of the 32-bit data packets may then be frequency shift keyed by the FSK encoder 130 as described, and transmitted on output 132. A band pass filter 140 may be provided and may be adapted to pass only the 9 MHz and 12 MHz frequency ranges to ensure a high quality digital output signal on output 142. In producing the FSK encoded output, the FSK encoder 130 utilizes a clock signal internal to the audio encoder 100. An output corresponding to this internal clock may be provided to accompany the output audio signal or the clock signal may be recovered on the receiving or decoding end as described below.

A video source 150 may also be provided to the summing junction 160 via signal path 152. The video source 150 may be connected via a standard Bayonet Neill Concelman (BNC) connector or another input suitable to the needs of the user. The video source may provide a video signal operating in a frequency range of up to 6 MHz. The video signal and the FSK audio signal may be combined at summing junction 160. The summing junction 160 may be a differential transmitter or other device capable of combining the audio and video signals. The summing junction 160 may comprise commercially available components, such as an operational amplifier, an ASIC, an FPGA, software for a general processing system, or a combination thereof. The combined signal consisting of the video signal and the audio signal, may be provided on output 162. The summing junction 160 may also provide additional amplification or signal conditioning as needed. In one embodiment, the output 162 may be an unshielded twisted pair (UTP) cable, although other physical carriers may also be suitable depending upon the needs of the user.

Referring now to FIG. 2, a flow chart 200 of one embodiment of a method of encoding audio data is shown. The flow chart 200 corresponds to one method of operation of the audio encoder 100 of FIG. 1. At step 210 the audio signal is received. As stated, the audio signal may include multiple channels of audio, such as with a stereo signal. As step 220 the received audio signal is converted from an analog signal to a digital signal. In one embodiment, each audio channel is sampled at 48 KHz producing a 24-bit sample. In other embodiments other frequencies and resolutions may be used. At step 225 headers may be added to the audio samples to indicate with which channel a given sample is associated. The headers may also provide additional functionality as described in greater detail below.

The digitized audio samples, or packets, including the headers are FSK encoded at step 230. The output from the FSK encoding step may be a single bit stream of digital audio samples with the header information indicting to which audio channel the packet belongs. In one embodiment, the 0's of the bit stream correspond to a signal of approximately 9 MHz while the 1's of the stream correspond to signal of approximately 12 MHz. At step 240, a filter may be provided that removes noise from the signal that does not correspond substantially to one of the two carrier frequencies. A high quality signal may then be provided for combination with a video signal at step 250. Additional signal conditioning and/or amplification may also be performed at step 250 or at other steps. The signal may be transmitted at step 260 by placing the signal on a UTP cable for example. As previously stated, a clock signal may be transmitted with the signal, or the clock signal may be recovered from the signal itself as described below.

Referring now to FIG. 3, a block diagram of an audio decoder 300 according to aspects of the present disclosure is shown. In one embodiment, the audio decoder 300 serves as an FSK detector corresponding to the encoder 100 of FIG. 1 described above. The audio decoder 300 decodes the signals transmitted by the encoder 100. In some embodiments, the encoder 100 and the decoder 300 will be implemented in the same package or combination. Thus, a pair of encoder/decoders would allow for two way communications including video and multi-channel audio over two UTP or coaxial cables. Moreover, for reach direction of communication, the audio and video signals are transmitted over the same UTP cable simultaneously. Therefore, latencies between reception and transmission of audio and video are minimal.

An input 305 is provided for the decoder 300 for receiving an input signal such as that provided on the output 162 of the audio encoder 100 described above. As described, the signal may include video and multi-channel audio. A filter 310 removes the video portion of the signal. The filter 310 may be a high-pass filter or a band-pass filter. As described, in one embodiment, the video source provides a video signal operating in a frequency range of up to 6 MHz, while the digitized audio signals are FSK encoded and carried on 9 MHz and 12 MHz frequencies. Thus the filter 310 may be designed as a high pass or band pass filter that blocks the video frequency but passes the audio frequencies. The filtered signal is provided on output 312 and is provided to an FSK decoder 320.

The FSK decoder 320 receives the digital audio signal as a bit stream. The FSK decoder 320 examines each packet to determine on which audio channel the sample should be placed. In one embodiment, the FSK decoder 320 utilizes a state machine 340 to determine to which channel an audio sample belongs based on an examination of the attached header. The FSK decoder 320 may recover or synchronize with the clock signal from the bit stream itself, as described in greater detail below. In the present embodiment the FSK decoder 320 provides the digital audio samples on output 322, which may be an I2C interface. In one embodiment, the output digital audio sample comprise 24 bit samples at 48 KHz, corresponding to the audio sample output from the encoder 100 of FIG. 1. A digital to analog (D/A) converter 330 converts the digital audio samples to analog signals and provides them on outputs 332, 334. Signal conditioning and amplification may be provided by the D/A converter 330 or by additional components. The outputs 332, 334 may be provided as left and right stereo audio channels, respectively, separate mono feeds, or other discrete signals. The outputs 332, 334 may be a standard stereo output jack, a balanced or unbalanced output, or another output as needed by the user.

A second filter 340 is provided for removing the FSK audio signal of the input signal from the input 305. In the present embodiment, the audio signals on the input 305 are at 9 MHz and 12 MHz, while the video signal is up to about 6 MHz. Therefore, a low pass filter may be employed. The video output signal is provided on output 342, free of the audio signal. The output 342 may be a BNC connection or another suitable output.

In operation, as described in greater detail below, the audio decoder 300 receives a bit stream as an input. The bit stream may be without an accompanying clock signal. In such case, the audio decoder 300 may make adjustments for variations in the different clock signals being used by the audio encoder 100 and the decoder 300. A state machine 345 may be provided to locate a known bit pattern in the input bit stream. A high speed oscillator or counter 350 may also be provided and attached to or integrated with one or more of the other components of the audio decoder 300. In one embodiment, the state machine 345 and the high speed counter 350 may be implemented as a part of the FSK decoder 320. The frequency of the high speed counter 350 may vary according to the needs of the user but is generally high enough to have multiple counts per clock cycle of the audio signal bit stream. In one embodiment a 73 MHz counter may be employed.

Referring now to FIG. 4, a flow chart 400 of one embodiment of a method of decoding audio data is shown. The flow chart 400 corresponds to one operating mode of the audio decoder 300 of FIG. 3. The input signal is received at step 410 which can include both video and multi-channel audio. At step 415 the video signal is filtered out and at step 420 the audio signal is filtered out to produce separate a separate FSK encoded audio signal and a video signal. At step 430 the FSK encoded audio signal is decoded before it is passed on to a D/A converter at step 440. The D/A conversion at step 440 provides the audio signal as a multi-channel, and possibly multi-lead, output signal. At step 450 the multi-channel audio signals and the video signal may each be provided as separate outputs.

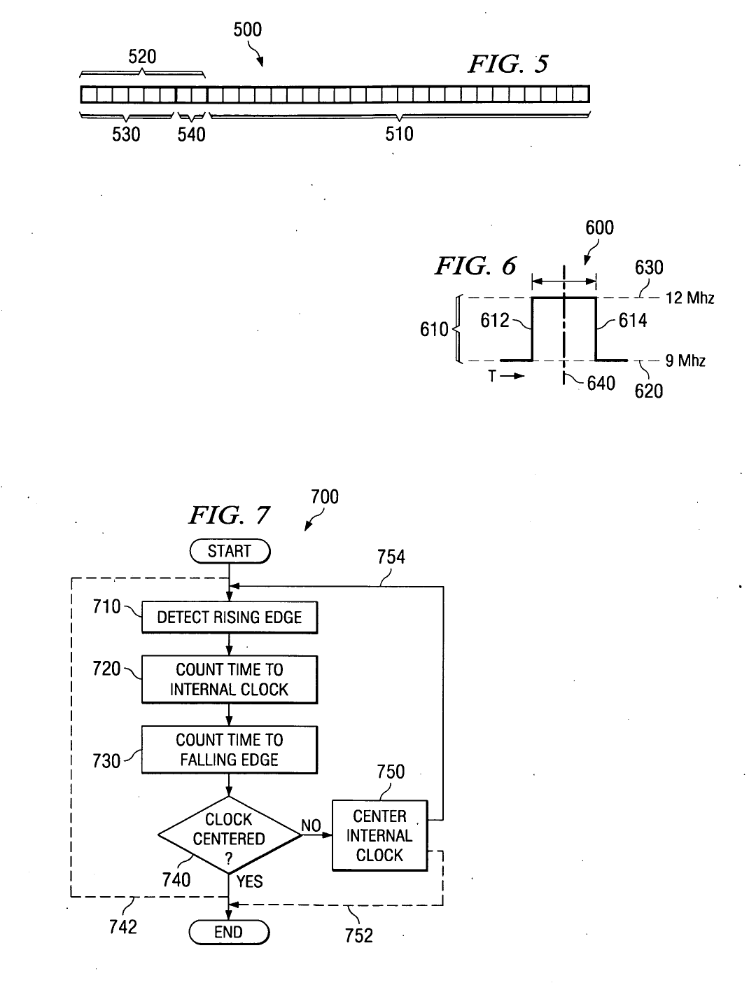

Referring now to FIG. 5, a logical diagram of one embodiment of a data packet 500 corresponding to encoded audio data according to aspects of the present disclosure is shown. The data packet 500 is shown with the header 520 attached to the digital audio sample 510. In this embodiment the digital audio sample is a 24-bit sample but other resolutions are possible. The attached header 520 is 8 bits in length resulting in a 32-bit data packet 500. The header 520 may contain multiple partitions such as an identification tag 530 and one or more parity bits 540. The identification tag 530 may provide a number of bits for identifying to which audio sample the packet 500 belongs. In one embodiment, the first four bits of the identification tag 530 may be designated to identify which of the two stereo audio channel the sample 500 belongs. For example, a bit pattern of 0101 or “5” in hexadecimal notation will correspond to a sample for the right audio channel, while a bit pattern of 1010 or “A” in hexadecimal notation will correspond to a sample for the left audio channel. As described below, the state machine 345 may read the incoming bit stream to determine whether a right or left channel sample is being transmitted. The header 520 is shown with two parity bits but more or fewer may be utilized as desired. In one embodiment, one parity bit corresponds to the header 520 while the other corresponds to the audio sample 510. The audio decoder 300, or a combined audio encoder/decoder, may repeat a sample if the parity bits indicate that an error has occurred.

Referring now to FIG. 6, a timing diagram 600 of a data signal according to aspects of the present disclosure is shown. The diagram 600 shows the data signal as a wave form 610 moving from a low state 620 on a 9 MHz carrier to a high state 630 on a 12 MHz carrier and then to the low state 620 again along the time axis T. The wave form 610 represents an FSK encoded bit stream as utilized by the audio encoder 100 of FIG. 1 and audio decoder 300 of FIG. 3. The wave form 610 corresponds to a 010 pattern in the bit stream. The wave form 610 has leading and trailing edges 612, 614, respectively. The dashed line 640 represents a presumed center of the high portion of the wave form 610.

Referring now also back to FIG. 3 and FIG. 1, as stated previously, the clock signal corresponding to the final output signal provided by the audio encoder 100 is generated by the audio encoder 100 itself. In some embodiments, the timing signal or clock signal is not provided to the audio decoder 300. In such case, the audio decoder 300 must acquire, follow, or synchronize with the clock signal originally used to generate the bit stream representing the audio portion of the output from the encoder 100. The audio decoder 300 may employ the state machine 345 to determine when the preamble 520 has been reached. The state machine may be integrated with the FSK decoder 320 or may be a separate component. Within the preamble one or more bits may be employed to provide a known signal shape. For example, the header may provide a known position within the bit stream where a 010 bit pattern occurs such that timing measurements may be made.

Referring now to FIG. 7, a flow chart 700 corresponding to one embodiment of a method for synchronizing with a clock signal according to aspects of the present disclosure is shown. The method of FIG. 7 may be used with the audio decoder 300 of FIG. 3. At step 710 the rising edge of the bit stream is detected. The high speed timer 350 may be employed to count at step 720 until the falling edge is detected at step 730. The number of counts that elapsed before and after the presumed center of the bit (line 640 of FIG. 6) is computed to determine if the clock is centered at step 740. If the clock is centered, the procedure may be ended, or, as shown by line 742, may repeat continually to monitor for drift in the presumed clock signal. If the clock signal is not centered at step 740, the internal presumed clock of the bit stream may be adjusted by moving the presumed clock 640 forward or backward a predetermined number of counts at step 750. In some embodiments the procedure is ended as shown by line 752. In other embodiments, the procedure may be repeated as shown by line 754 to continually monitor for drift in the presumed clock signal.

It will be appreciated by those skilled in the art having the benefit of this disclosure that this invention provides a broadband information appliance. It should be understood that The drawings and detailed description herein are to be regarded in an illustrative rather than a restrictive manner, and are not intended to limit The invention to The particular forms and examples disclosed. On The contrary, The invention includes any further modifications, changes, rearrangements, substitutions, alternatives, design choices, and embodiments apparent to those of ordinary skill in The art, without departing from The spirit and scope of this invention, as defined by The following claims. Thus, it is intended that he following claims be interpreted to embrace all such further modifications, changes, rearrangements, substitutions, alternatives, design choices, and embodiments.

What is claimed is:

1. A method of transmitting audio signals, comprising:
receiving a multi-channel analog audio signal;
converting the analog audio signal to a digital audio signal having a plurality of discrete audio samples with a first sample bit length and a first sample rate;
providing a header for each discrete sample of the digital audio signal to produce a sample packet with a second sample bit length;
frequency shift key (FSK) encoding the sample packets on first and second audio transmission frequencies; and
transmitting the sample packets.

2. The method of claim 1, further comprising:
receiving the sample packets; and
FSK decoding the sample packets to produce received digital audio samples.

3. The method of claim 2, further comprising converting the received digital audio samples into a plurality of analog audio output signals.

4. The method of claim 1 wherein the header of each discrete sample comprises a channel indicator.

5. The method of claim 1 wherein the first sample bit length is 24 bits and the first sample rate is 48 kHz.

6. The method of claim 1 wherein the second sample bit length is 32 bits.

7. The method of claim 1 wherein the header of each discrete sample comprises at least one parity bit.

8. The method of claim 1 wherein the step of transmitting comprises transmitting the sample packets over a single unshielded twisted pair (UTP) cable.

9. The method of claim 1, further comprising:
receiving a video signal on a first video frequency;
transmitting the video signal at the first video frequency substantially simultaneously with the sample packets.

10. The method of claim 9, further comprising:
receiving the transmitted video signal and the sample packets at a receiving location
applying filters to remove the video signal from the received signal;
FSK decoding the sample packets to produce a decoded digital audio signal; and
converting the decoded digital audio signal to an analog audio output signal.

11. The method of claim 10, further comprising
reading a header portion from at least one sample packet;
establishing a presumed clock timing based upon a known bit pattern in the header;
determining a first length of time from a first edge of a known bit in the known bit pattern to the clock pulse location in the known bit based on the presumed clock timing;
determining a second length of time from a clock pulse location in the known bit based on the presumed clock timing to the second edge of the known bit in the known bit pattern; and
adjusting the presumed clock timing such that the first length of time and second length of time are substantially equal.

12. A method of transmitting and receiving multi-channel audio signals and video signals on a common connection, comprising:
providing a video signal at a video signal frequency;
digitally encoding an audio signal to produce a digital audio signal having a plurality of samples and providing a header on each sample of the audio signal identifying the channel associated with the sample;
frequency shift key (FSK) encoding the digital audio samples on first and second audio carrier frequencies;
transmitting the video signal and the FSK audio signal simultaneously on a common line from a transmitting location to a receiving location;
receiving the transmitted video and audio signal at the receiving location;
providing a first filter for removing the video signal from the transmitted video and audio and a second filter for removing the audio from the transmitted video and audio; and
FSK decoding the filtered audio signal.

13. The method of claim 12, further comprising:
reading a header from at least one sample of the digital audio signal;
establishing a presumed clock timing based upon a known bit pattern in the header;
determining a first length of time from a first edge of a known bit in the known bit pattern to a clock pulse location in the known bit based on the presumed clock timing;
determining a second length of time from the clock pulse location in the known bit based on the presumed clock timing to the second edge of the known bit in the known bit pattern; and
adjusting the presumed clock such that the first length of time and second length of time are substantially equal.

14. A method for recovering a clock signal from an FSK encoded, multi-channel audio signal bit stream, comprising:
determining when a header portion of an audio sample in the bit stream is being transmitted;
establishing a presumed clock timing based upon a known bit pattern in the header portion;
determining a first length of time from a first edge of a known bit in the known bit pattern to a clock pulse location in the known bit based on the presumed clock timing;
determining a second length of time from the clock pulse location in the known bit based on the presumed clock timing to the second edge of the known bit in the known bit pattern; and
adjusting the presumed clock timing such that the first length of time and second length of time are substantially equal.

15. The method of claim 14 wherein determining when a header portion of an audio sample in the bit stream is being transmitted further comprises utilizing a state machine to determine when a header portion of an audio sample in the bit stream is being transmitted.

16. The method of claim 14 wherein the steps of determining a first length of time and determining a second length of time include utilizing a high speed counter to mark the passage of time.

17. A system for providing multi-channel audio and video on a common transmission line comprising:
an analog to digital (A/D) converter adapted to digitize a multi-channel audio input signal;
an frequency shift key (FSK) encoder adapted to FSK encode the digitized audio input signal;
a transmitter adapted to transmit the FSK encoded audio signal on a common unshielded twisted pair (UTP) cable with a video signal;
a receiver adapted to receive the transmitted audio signal
an FSK decoder adapted to decode the transmitted audio signal to produce a received digital audio signal; and
an analog to digital (A/D) converter adapted to convert the received digital audio signal to produce an analog audio output signal.

18. The system of claim 17, further comprising:
a high speed counter; and
a state machine;
wherein the state machine is adapted to determine at least one channel of the multi-channel audio input signal to which a sample from the received digital audio channel corresponds based upon a header associated with a sample from the received digital audio channel;
wherein the FSK decoder establishes a presumed clock timing based upon a known bit pattern in the header, determines a first length of time from a first edge of a known bit in the known bit pattern to a clock pulse location in the known bit based on the presumed clock timing, determines a second length of time from the clock pulse location in the known bit based on the presumed clock timing to the second edge of the known bit in the known bit pattern, and adjusts the presumed clock timing such that the first length of time and second length of time are substantially equal.

19. A method of receiving an audiovisual signal from a unshielded twisted pair (UTP) transmission line comprising:
receiving an input signal including a video signal portion on a video carrier frequency and an audio signal portion frequency shift keyed to a first and second audio carrier frequency, the first and second audio carrier frequencies being higher than the video carrier frequency;
applying at least one filter to separate the video portion from the audio portion; and
frequency shift key (FSK) decoding the separated audio portion to produce a digital audio signal.

20. The method of claim 19 further comprising:
reading a header portion from a discrete sample packet from the digital audio signal;
establishing a presumed clock timing based upon a known bit pattern in the header;
determining a first length of time from a first edge of a known bit in the known bit pattern to the clock pulse location in the known bit based on the presumed clock timing;
determining a second length of time from a clock pulse location in the known bit based on the presumed clock timing to the second edge of the known bit in the known bit pattern; and
adjusting the presumed clock timing such that the first length of time and second length of time are substantially equal.
